(19) United States
(12) Patent Application Publication
(10) Pub. No.: US 2023/0158834 A1
(43) Pub. Date: May 25, 2023

(54) NON-PNEUMATIC TIRE SPOKE WITH IMPPROVED ELASTOMERIC JOINT BODY

(71) Applicants: Kevin Corbett MILES, Greenville, SC (US); Steven M. CRON, Greenville, SC (US); Compagnie Generale des Etablissements Michelin, Clermont-Ferrand (FR)

(72) Inventors: Kevin Corbett MILES, Clemson, SC (US); Steven M CRON, Simpsonville, SC (US)

(21) Appl. No.: 17/786,002

(22) PCT Filed: Dec. 16, 2019
(86) PCT No.: PCT/US19/66489

§ 371 Date: Jun. 16, 2022

(51) Int. Cl. B60C 7/14

(52) U.S. Cl. CPC B60C 7/146

(57) ABSTRACT

An improved spoke (100) for a tire (10) attaching an outer tread to a hub (12), the spoke (100) having a spoke element possessing spoke element reinforcements, the spoke element joined by a joint body (114) comprised of an elastomer connecting the spoke element to an outer compliant band (200) where the joint body (114) possesses an improved profile for increased robustness.

### FIELD OF THE INVENTION

The subject matter of the present invention relates to a support structure for a nonpneumatic tire and specifically to improvements to the elastomeric joint bodies of such a support structure.

### BACKGROUND

Composite spoke structures have been used to support non-pneumatic tires and may be comprised of an elastomer and a second material having a relatively higher bending stiffness than the elastomer, the composite spring having a first hinge side and a second hinge side comprised of the second material, and a joint body comprised of the elastomer, where the second material comprising the first hinge side and second hinge side are discontinuous or otherwise separated from one another by the joint body connecting the first hinge side and the second hinge side.

FIG. 2 provides a sectional view of one such prior art spoke 100′. The nose portion, or otherwise referred to as the “joint body” 130 of the spoke 100′ is comprised of an elastomeric material and acts to connect a first support element and a second support element, here comprising a radially outer support element or “leg” 144 and a radially inner support element or “leg”142 respectively. The nose joint body is thicker, as measured in the circumferential direction (“C”), between the radially inner leg 142 and radially outer leg 144 than it is closer to the radially inner or radially outer portions of the joint body 130. In reference to a single spoke as shown in this embodiment, the circumferential direction “C” is generally orthogonal to both the radial direction and the lateral direction.

When the spoke is compressed, which would occur in this particular spoke by moving the radially outer elastomeric joint body 114 toward the radially inner elastomeric joint body 112, the elastomeric portion of the nose joint body 130 compresses and tension develops toward the ends 146, 148, 156, 158 of the legs 142, 144. Over prolonged use or under high stress, cracks may develop adjacent to the radial ends 146, 148, 156, 158 of the legs 142, 144, and particularly at the radially outer end 148 of the radially outer leg 142, and may result in crack formation or other tearing. Particularly, cracks may form at the interface between the support element reinforcements and the rubber they are imbedded in at the radially outer end of the radial outer support element.

An improved spoke construction having an improved durability would be useful. It would be particularly useful for an improved spoke construction that would prolong the useful life of the spoke by delaying, reducing or eliminating the likelihood of crack formation or tearing.

### SUMMARY OF THE INVENTION

Aspects and advantages of the invention will be set forth in part in the following description, or may be obvious from the description, or may be learned through practice of the invention.

The invention disclosed herein possesses an improved geometry aimed at reducing crack initiation at the circumferential distal surface of an elastomeric joint body of a composite non-pneumatic tire support. The improved geometry, inter alia, directs excess adhesive material, when present, away from the circumferential distal surface of the elastomeric joint body preventing adhesive material from attaching at a location at or adjacent to peak stresses along the circumferentially distal surface, increasing its durability and resistance to cracking.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a lateral side view of an exemplary embodiment of the present invention where a plurality of resilient composite structures are configured as spokes forming a part of a tire depicted under nominal loading conditions.

FIG. 2 provides a perspective view of a prior art structural support in the form of a spoke for a non-pneumatic tire.

FIG. 3 provides a lateral view of a finite element model of the stress concentration in the radially outer elastomeric joint body during compression, the embodiment lacking a glue deflecting flap.

FIG. 4 provides a lateral cross-section view schematic of the radially outer elastomeric joint body during compression, the embodiment lacking a glue deflecting flap, showing a typical glue distribution and excess glue beading and cracking of the elastomeric joint body.

FIG. 5 shows a cutaway perspective view of an embodiment of the invention showing the glue deflecting flap on the radially inner elastomeric joint body and radially outer elastomeric joint body.

FIG. 6 provides a close-up cross-section lateral view of the radially outer elastomeric joint body radially outer end of the radially outer support element and outer compliant band of an embodiment of the invention.

FIG. 7 shows a finite element model of the stress concentration in the radially outer elastomeric joint body during compression of an embodiment having a glue deflecting flap.

The use of identical or similar reference numerals in different figures denotes identical or similar features.

### DETAILED DESCRIPTION OF THE INVENTION

The present invention provides an improvement to a mechanical structure for resiliently supporting a load. For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

The following terms are defined as follows for this disclosure:

“Axial direction” refers to a direction parallel to the axis of rotation of for example, the shear band, tire, and/or wheel as it travels along a road surface.

“Radial direction” or the letter “R” in the figures refers to a direction that is orthogonal to the axial direction and extends in the same direction as any radius that extends orthogonally from the axial direction.

“Equatorial plane” means a plane that passes perpendicular to the axis of rotation and bisects the outer compliant band and/or tire structure.

“Circumferential direction” or the letter “C” in the figures refers to a direction that is orthogonal to the axial direction and orthogonal to a radial direction.

“Lateral direction” or the letter “L” means a direction that is orthogonal to an equatorial plane.

“Elastic material” or “Elastomer” as used herein refers to a polymer exhibiting rubber-like elasticity, such as a material comprising rubber.

“Elastomeric” as used herein refers to a material comprising an elastic material or elastomer, such as a material comprising rubber.

“Interior angle” or “Internal angle” as used herein means an angle formed between two surfaces that is greater than 0 degrees but less than 180 degrees. An acute angle, a right angle and an obtuse angle would all be considered “interior angles” as the term is used herein.

“Exterior angle” or “External angle” or “Reflex angle” as used herein means an angle formed between two surfaces that is greater than 180 degrees but less than 360 degrees.

“Nominal load” or “desired design load” is a load for which the structure is designed to carry. More specifically, when used in the context of a wheel or tire, “nominal load” refers to the load for which the wheel or tire is designed to carry and operate under. The nominal load or desired design load includes loads up to and including the maximum load specified by the manufacturer and, in the case of a vehicle tire, often indicated by marking on the side of the tire. A loading condition in excess of the nominal load may be sustained by the structure, but with the possibility of structural damage, accelerated wear, or reduced performance A loading condition of less than nominal load, but more than an unloaded state, may be considered a nominal load, though deflections will likely be less than deflections at nominal load.

“Modulus” or “Modulus of elongation” (MPa) was measured at 10% (MA10) at a temperature of 23° C. based on ASTM Standard D412 on dumb bell test pieces. The measurements were taken in the second elongation; i.e., after an accommodation cycle. These measurements are secant moduli in MPa, based on the original cross section of the test piece.

“Distal” is a direction away from the mass center of spoke.

“Proximal” is a direction toward or closer to the mass center of the spoke.

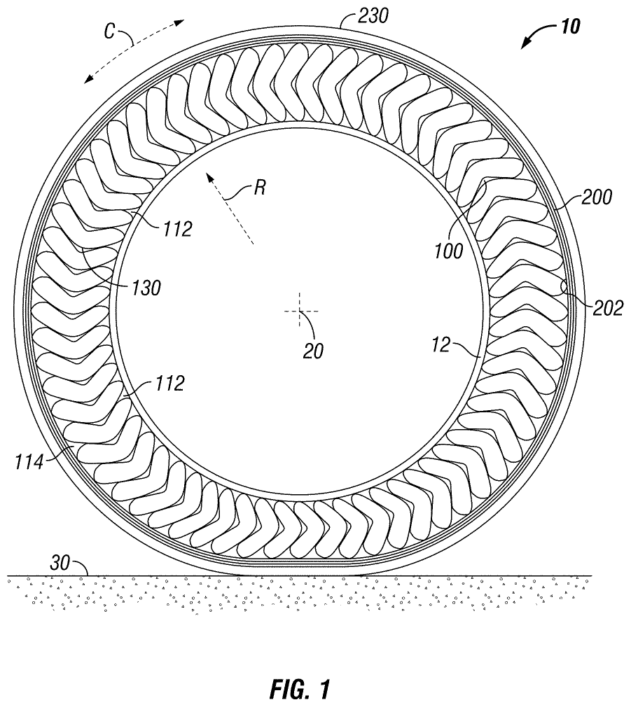

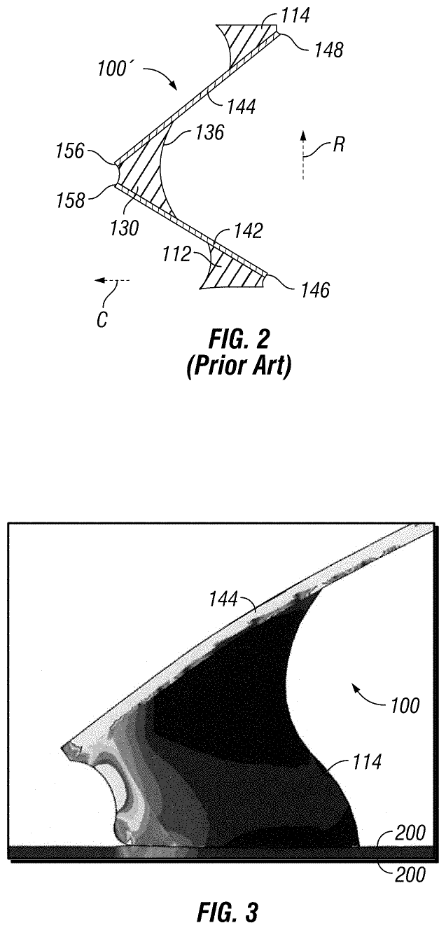

FIG. 1 shows a lateral side view of an exemplary embodiment of the present invention wherein a plurality of resilient composite structures are configured as spokes 100 and are attached to an outer compliant band 200 forming a part of a tire 10. The tire 10 may be incorporated into a wheel for a vehicle. For example the tire 10 may be part of a non-pneumatic wheel having a hub 12 which is attached to a passenger vehicle allowing the vehicle to roll across a ground surface. Other objects and vehicles may incorporate the invention, including but not limited to: heavy duty truck, trailer, light truck, off-road, ATV, bus, aircraft, agricultural, mining, bicycle, motorcycle and passenger vehicle tires. Such a non-pneumatic wheel would possess a hub 12 that would have a radially outer surface having an axis of revolution about a central axis 20. The tire 10 may be attached to the hub 12 by any of a number of methods, for example, by mechanical fasteners such as bolts, screws, clamps or slots, and/or by adhesives such as cyanoacrylates, polyurethane adhesives, and/or by other bonding materials or a combination thereof.

The tire 10 shown here possesses an axis of rotation 20 about which the tire 10 rotates. In this exemplary embodiment, the radially outer surface 230 of the outer compliant band 200 interfaces with a ground surface 30 over which the tire rolls forming a contact patch, or area of the outer compliant band 200 that conforms to the surface upon which it is in contact with. Under a nominal load, the spokes 100 of the tire flex as the tire enters and exits the contact patch. Smaller deflections occur in the spokes 100 as the spoke rotates about the axis 20 outside the contact patch, but most of the deflection occurs while the spoke 100 enters, exits and travels through the contact patch.

Each spoke 100 possesses a “nose” portion 130 which acts as a resilient hinge. The “nose” portion 130 is an elastomeric joint body connecting a support element forming the radially inner portion of the spoke and a support element forming the radially outer portion of the spoke. The support elements of the spoke 100 are initially positioned at an angle relative to each other. The angle between the spoke support elements measuring less than 180 degrees is the interior angle and the angle between the spoke support elements measuring greater than 180 degrees is the exterior angle. The nose elastomeric joint body 130 is comprised of an elastomer attached to each spoke support element and is positioned on the side where of the radially outer spoke element and radially inner spoke element form an interior angle.

In this embodiment, the radially inner portion of the spoke possesses a radially inner foot 112 which connects to another surface, which is the radially outer surface of the hub 12 in the present embodiment. Here, the radially inner foot 112 is comprised of an elastomeric joint body that connects the radially outer support to the hub 12. The radially outer portion of the spoke 100 possesses a radially outer foot 114 which is comprised of another elastomeric joint body which connects the outer support element to yet another surface which is, in the present embodiment, the radially inner surface 202 of the outer compliant band 200.

In the exemplary embodiment shown, the tread band 200 comprises an elastomeric material and allows deformation to form a planar footprint in the contact patch. In the exemplary embodiment shown, the radially outer foot 114 of the spoke 100 is attached to the radially inner surface 202 of the tread band 200 and to the opposite side of the support element from the nose portion 130. In the exemplary embodiment shown, the spoke is adhered in place by an adhesive. In other embodiments, the spoke may be attached by other methods, including by adhering the elastomeric material together, for instance by using green rubber and curing the rubber components together, or using a strip of green rubber between cured or partially cured rubber components. In some embodiments, the outer compliant band 200 may also possess a reinforcement to help carry the load circumferentially around the tire.

For this particular embodiment, the size of the tire 100 is equivalent to a pneumatic tire of the size 215/45R17. In the particular embodiment shown, 64 spokes 100 are attached around the inner circumference of the outer compliant band 200. Under nominal loading conditions the tire 10 deflects 20 mm from the unloaded state. In the exemplary embodiment, 500 kg of mass load (approximately 4,900 N force) was used to approximate the nominal loading condition of the tire.

FIG. 3 provides a lateral elevation view of a finite element model of a spoke 100 undergoing compression, the model showing the tensile stress values within the composite structure with higher values shown in grey and red, and lower values shown in blue and black. Under compression of the spoke 100, the circumferentially distal portion of the radially outer elastomeric joint body 114 undergoes tension while the circumferentially medial portion of the radially outer elastomeric joint body undergoes compression. It can be observed that tension between the radially outer end of the radially outer support element and the outer compliant band 200 is the highest toward middle portion and relatively less nearer the outer complaint band 200 radially inner surface 202.

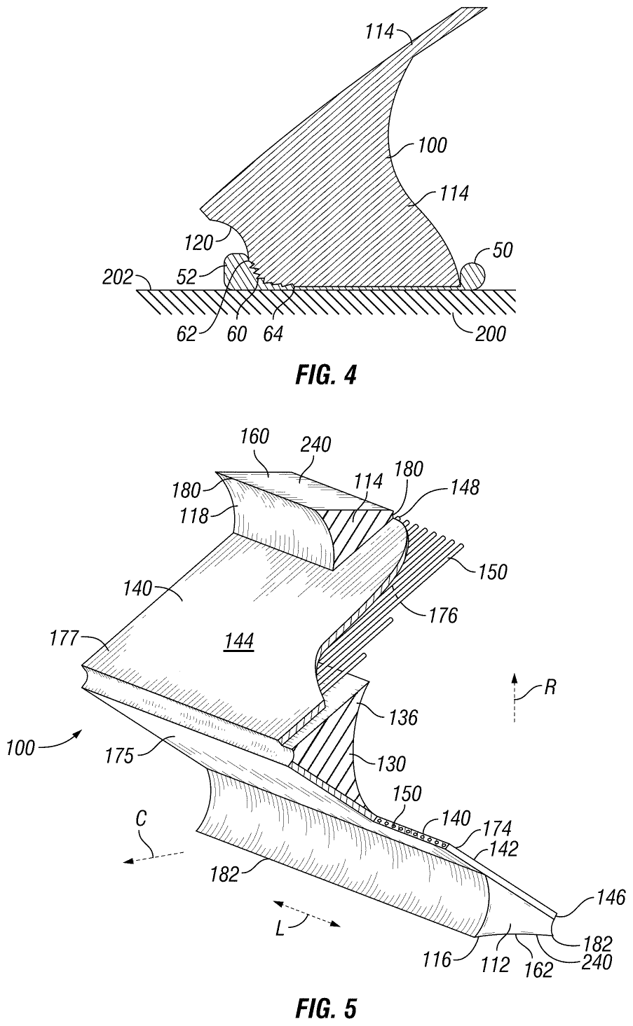

When the spoke 100 is attached to the compliant band 200, a bonding layer 50 is typically used to secure the spoke 100 to the outer surface 202 of the compliant band as shown in FIG. 4. In this embodiment, the bonding layer 50 is an adhesive. A small bead 52 usually forms at the distal end of the interface between the spoke and complaint band as a small amount of the material making up the bonding layer 50 is squeezed out. The bead 52 adheres to the first surface 120 of the radially outer elastomeric joint body and to the outer surface 202 of the compliant band. Higher tensile stress at the glue 50—elastomeric joint body 114 interface create sufficient energy in the material to initiate a crack 60 at a crack initiation location 62 and extending to a terminal end 64. As the spoke is cycled and the crack is exposed to sufficient stress, the crack will continue to grow until the crack is discovered and intervention is taken or the spoke 100 separates from the outer compliant band 200. The radially outer elastomeric joint body 112 radially outer surface 160 joins to the radially inner surface 202 of the tread band 200.

FIG. 5 provides a perspective cutaway view of an embodiment of the current invention. In the current embodiment, the circumferentially distal most edge 180 between the elastomeric joint body 112 and the shearband's 200 radially inner surface 202 is pushed farther away from the first surface of the radially outer joint body 102 by an extension of the joint body 114 forming a glue deflector flap 240. The glue deflector flap 240 places the bead 52 formed from excess bonding material 50 farther from the first surface 120 of the radially outer joint body 114 reducing the likelihood of it bonding to the first surface 120 creating a stress riser and crack initiation point.

The nose portion, or otherwise referred to as the “nose joint body” 130 of the spoke 100 is comprised of an elastomeric material and acts to connect a first support element and a second support element, here comprising a radially outer leg 144 and a radially inner leg 142 respectively. The nose portion becomes circumferentially thicker as measured in the circumferential direction (“C”) between the radially inner leg 142 and radially outer leg 144 as you get closer to the halfway point between the radially inner leg 142 and radially outer leg 144. The nose elastomeric joint body 130 is radially thicker between the radially inner leg 142 and radially outer leg 144 as you move away from the nose portion of the spoke in the circumferential direction C. In reference to a single spoke as shown in this embodiment, the circumferential direction is generally orthogonal to both the radial direction and the lateral direction.

The support elements 112, 114 of the spoke 100 are referred herein as having a first side 174, 176 and a second side 175, 177. The radially outer elastomeric joint body 114 is positioned on the second side 177 of the radially outer support element 144 and the radially inner elastomeric joint body 112 is positioned on the second side 175 of the radially inner support element 142. The nose elastomeric joint body is positioned on the first sides 174, 176 of both the radially outer support element 144 and the radially inner support element 142.

When the spoke is compressed, which would occur in this particular spoke by moving the radially outer elastomeric joint body 114 toward the radially inner elastomeric joint body 112, the thicker portion of the nose elastomeric joint body 130 compresses and radial tension develops in the thinner portion of the nose elastomeric joint body as the support elements hinge about the nose elastomeric joint body. During compression of the spoke, the radially outer elastomeric joint body 114 and radially inner elastomeric joint body 112 also undergo compression in the radially thicker portion of the joint body and tension in the radially thinner portion of the joint body closer to the ends of the support element 142, 144 ends 146, 148.

Likewise, when the spoke 100 is deformed radially inward, undergoing compression between the radially outer foot 114 and radially inner foot 112, the nose elastomeric joint body 130 undergoes compression between the radially inner support element 142 and radially outer support element 144 of the spoke while the distal portion of the nose elastomeric joint body 130 undergoes tension between the radially inner support element 142 and the radially outer support element 144.

Reinforcements 150 in the support elements 142, 144 provide flexural stiffness beyond that which the surrounding material can provide alone. The reinforcements may be constructed from any resilient material having a flexural stiffness greater than the elastomeric joint bodies. In this particular embodiment the reinforcements 150 are comprised of pultruded fiberglass reinforced resin. Other materials may be used, including metal, including spring steel, carbon fiber, fiber reinforced resins or fiber reinforced plastics. The reinforcements 150 of the current embodiment are oriented along the length of the support element 142, 144 and generally along the length of the spoke such that they lie parallel to the equatorial plane of the tire.

The spoke 100 of the embodiment shown, including the elastomeric joint bodies 112, 114, 130 and the material surrounding the reinforcement 150, is comprised of rubber of the general type used in the construction of conventional rubber pneumatic radial tires.

The rubber used in the embodiment shown is of a relatively soft rubber having a modulus of 3.2 MPa in the areas of the radially inner elastomeric joint body 112 and radially outer elastomeric joint body 114. Each elastomeric joint body 112, 114 is attached to the radially inner leg 142 and radially outer leg 144 respectively. The radially inner leg 142 and radially outer leg 144 are constructed to give them flexural rigidity, that is, to allow them to resiliently deform when the spoke 100 is under compression or tension. In the current embodiment, radially outer end 148 of the radially outer leg 144 is attached to the elastomeric joint body 114, but is otherwise “free” and may move to compress or stretch the elastomeric joint body 114 when the spoke is being stretched or compressed. Likewise the radially inner end 146 of the radially inner leg 142 is attached to the elastomeric joint body 112, but is otherwise “free” and may move to compress or stretch the elastomeric joint body 112 when the spoke 100 is under compression or tension. The radially inner elastomeric joint body 112 generally becomes thicker in the circumferential direction nearer the hub 12 to which it is attached than it is near the radially outer portion of the elastomeric joint body. It should be understood, however, as in the embodiment shown, it may become circumferentially thinner at points due to the profile of the geometry near the surface of the hub. In the embodiment shown, the elastomeric joint body 112 flairs outward forming a protrusion 116 nearest the hub 10. Likewise, the radially outer elastomeric joint body 114 generally becomes thicker in the circumferential direction nearer the outer band 200 to which it is attached compared to the radially inner portion of the elastomeric joint body 114. In the embodiment shown, the elastomeric joint body 114 flairs outward forming a protrusion 118 nearest the outer band 200.

The legs 142, 144 of the spoke 100 may be comprised of fiber reinforced plastic reinforcements surrounded by a rubber to form a membrane. In this embodiment the leg membranes 142, 144 possess a flexural rigidity of approximately 40 GPa. In this particular embodiment, the filaments have a diameter of approximately 1 mm with a pace of about 2 mm apart. The filaments of the particular embodiment shown are glass reinforced resin formed by pultrusion. The filaments of the embodiment have a modulus of approximately 10 MPa to 40 GPa. Alternatively other reinforcements may be used, including carbon fiber such as graphite epoxy, glass epoxy or aramid reinforced resins or epoxy or combinations thereof. Unreinforced plastic reinforcements or metallic reinforcements may also be used, provided they have sufficient flexural rigidity for the nominal loads intended to be supported. Alternatively other pacing and other diameters of the membranes and reinforcements may be used. The legs 142, 144 of the spoke 100 have a relatively large stiffness compared to the other components comprising the spoke 100. The legs 142, 144 act resiliently and have a large bending stiffness allowing the nose portion 130 of the spoke to act as a joint body connecting the radially inner leg 142 with the radially outer leg 144. The feet 112, 114 act as second and third joint bodies, connecting the radially inner leg 142 to the hub and the radially outer leg 144 with the outer band 200.

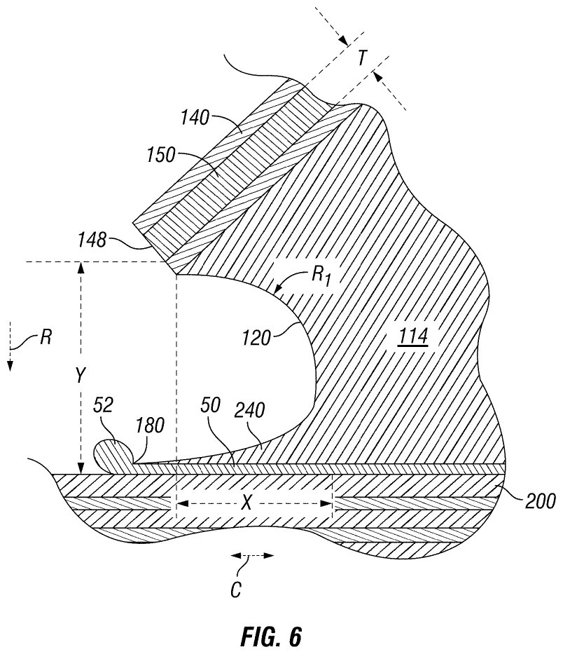

In FIG. 6, the distance in the radial direction R from the end 148 of the support element reinforcement 150 to the radially inner surface 202 outer compliant band 200 is shown as “Y” while the maximum distance in the circumferential direction C from the end 148 of the support element reinforcement 150 to the first surface 120 of the elastomeric joint body 114 is shown as “X”. The edge 180 is the circumferentially distal edge of the elastomeric joint body 114 where it joins with the outer compliant band 200. The distal surface 120 is the surface of the elastomeric joint body 114 between the support element 140 and the outer compliant band 200. The edge 180 extends circumferentially out from the distal surface 120 forming a glue deflector flap 240. In this embodiment, the edge 180 is radially in line with the radially outer end 148 of the radially outer support element 140. The thickness of the support element reinforcement is shown as “T” in the figure and is measured here in the medial plane of the non-pneumatic tire and perpendicular to the surface of the support element reinforcement. The inventors have found improved durability of the interface between the elastomeric joint body 114 and the outer shear band 200 is achieved when the dimensions Y and X are at least twice that of the thickness T of the support element reinforcement 150. The inventors have found further improved durability when the spoke dimensions Y and X are at least three times the thickness T of the elongated reinforcement. Durability is further enhanced when a predominantly concave radius R1 is present between the end 148 of the reinforcement 150 and the edge 180 of the elastomeric joint body 114. The radius need not be constant as it may have a variable radius value. In this particular embodiment, the radius has an inflection where the concave radius R1 becomes convex the radially distal surface 120 of the elastomeric joint body 114 possesses a convex curved radius R2, as shown near the edge 180 of the current embodiment.

The glue deflector flap 240 may extend in the circumferential direction C from the most medial location of the first surface 120 of the radially outer elastomeric joint body 114 a distance equal to or greater than the thickness of the reinforcement 150. For example, in an alternative embodiment, the glue deflector flap 240 extends in the circumferential direction C from the most medial location of the first surface 120 of the radially outer elastomeric joint body 114 a distance equal to the thickness of the reinforcement 150. In another alternative embodiment, the glue deflector flap 240 extends in the circumferential direction C from the most medial location of the first surface 120 of the radially outer elastomeric joint body 114 a distance equal to twice the thickness of the reinforcement 150. In yet another alternative embodiment, the glue deflector flap 240 extends in the circumferential direction C a distance that is circumferentially more distal from the spoke 100 than the radially outer end 148 of the radially outer support element 140.

The inventors have found that spoke endurance performance is particularly good when the reinforcement 150 thickness T is approximately 1 mm and the radial distance Y is approximately 4 mm and the distance X in the circumferential direction is 3 mm. In this embodiment, the glue flap 240 extends further in the circumferential direction than any other part of the first surface 120 of the elastomeric join body 114.

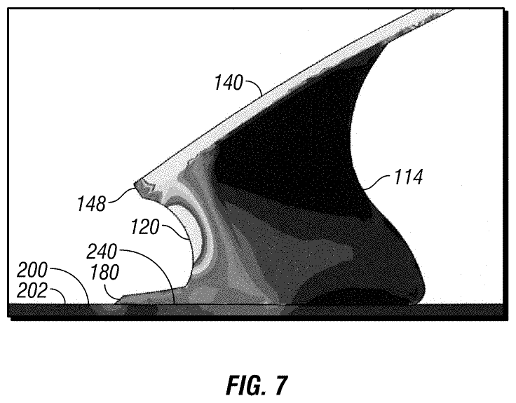

FIG. 7 shows a computer model of a portion of the radially outer portion of the spoke and the outer compliant band under a nominal load deflection, that is, a 20 mm compression of the spoke which simulates a 20 mm displacement of the outer compliant band 200 toward the hub 12. FIG. 7 is a computer model of an embodiment where the thickness of the reinforcement is 1 mm and the circumferential distance X between the end of the reinforcement 150 and the circumferentially farthest distance to the distal surface 120 of the radially outer elastomeric joint body 114 from the edge 180 of the adhesive deflector flap 240 is 3 mm and the radial distance Y between the end of the reinforcement and the radially inner surface 202 of the tread band 200 is 4.3 mm. The location of the edge 180 away from the higher stress along the distal surface 120 positions any excess bonding material, such as excessive adhesive, well away from the areas of higher stress. This corresponds to the inventors' observation of improved durability in the experimental testing of the embodiment of the current invention which possesses the adhesive deflector flap 240 as modeled here.

The “v-shape” of the embodiments of the spoke shown and described herein allow the adjacent spokes to “nest” and give linear spring rate when deflected radially over a distance approximately equal to the tires vertical deflection. The nesting of the spokes avoid adjacent spokes from clashing under normal loading conditions.

It should be understood by a person of ordinary skill in the art that the stiffness of the spoke may be adjusted by adjusting the length of the “v” of the “v-shaped spoke”, the constituent material moduli and the internal architecture of the spoke.

It should be understood that other web element configurations and geometries may be used within the scope of the invention, including web elements which are interconnected such as where they may form a honeycomb or other pattern. While when the resilient composite structure is configured as a spoke they are configured to extend in a lateral direction across the width of the tire, it should be understood that they may be configured at other angles, such as at an angle to the lateral direction of the tire. For example, the spoke may extend at a diagonal between the circumferential direction and the lateral direction of the tire. In yet other embodiments, the spoke may be turned 90 degrees to run circumferentially around the diameter of the tire, thereby resembling a sidewall of a pneumatic tire. In such a configuration, the spoke would be configured like a continuous toroid about the hub of the wheel.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” Also, the dimensions and values disclosed herein are not limited to a specified unit of measurement. For example, dimensions expressed in English units are understood to include equivalent dimensions in metric and other units (e.g., a dimension disclosed as “1 inch” is intended to mean an equivalent dimension of “2.5 cm”).

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.”

1-15. (canceled)

16. A spoke for a non-pneumatic tire for connecting a radially inner surface of an outer compliant band to a radially outer surface of a hub, the tire defining an axis of rotation about its center and a medial plane tangent to the axis of rotation, the spoke comprising:
a radially outer support element having a radially inner end, a radially outer end, a first side and a second side;
a radially outer elastomeric joint body connecting the radially outer end of the radially outer support element to the radially inner surface of the outer compliant band, the radially outer elastomeric joint body positioned on the second side of the radially outer support element, the elastomeric joint body having a first surface on the same side of the radially outer elastomeric joint body as the first side of the radially outer support element and a second surface on the same side of the radially outer elastomeric joint body as the second side of the radially outer support element;
wherein the radially outer support element is comprised of one or more elongated reinforcements having a rigidity greater than the elastomer comprising the radially outer elastomeric joint body, the elongated reinforcement having a thickness;
wherein the radially outer end of the radially outer support element is positioned from the radially inner surface of the outer compliant band a first distance Y measured in the radial direction of the tire of at least twice that of the thickness T of the elongated reinforcement; and
the radially outer end of the radially outer element is positioned from the first surface of the radially outer elastomeric joint body a second distance X measured in the circumferential direction of the tire of at least twice that of the thickness T of the elongated reinforcement;
wherein the radially outer elastomeric joint body extends in a circumferential direction at the radially outer end of the first surface of the elastomeric joint body forming an outer elastomeric joint body flap.

17. The spoke of claim 16 further comprising:
a radially inner support element having a radially inner end, a radially outer end, a first side and a second side, the radially outer support element forming an interior angle with the radially inner support element, the interior angle positioned on a first side of the radially outer support element and a first side of the radially inner element;
a middle elastomeric joint body connecting the radially inner support element radially outer end and the radially outer support element radially inner end, the middle elastomeric joint body positioned on the first side the radially outer support element and the first side of the radially inner support element.

18. The spoke of claim 17 further comprising:
a radially inner elastomeric joint body connecting the radially inner support element radially inner end to the radially hub and positioned on the second side of the radially inner support element.

19. The spoke of claim 17 wherein the radially inner support element is comprised of one or more elongated reinforcements having a rigidity greater than the elastomer comprising the radially outer joint body.

20. The spoke of claim 16 wherein the radially outer support element radially outer end is a free end.

21. The spoke of claim 16 where the first surface of the radially outer elastomeric joint body possesses a concave radius.

22. The spoke of claim 16 wherein the first distance and the second distance is at least three times the thickness of the elongated reinforcement.

23. The spoke of claim 16 wherein the thickness of the reinforcement is 1 mm and the first distance is 4 mm and the second distance is 3 mm.

24. The spoke of claim 16 wherein the thickness of the reinforcement is 1 mm and the first distance is 4.3 mm and the second distance is 3.0 mm.

25. The spoke of claim 16 where the first surface of the radially outer elastomeric joint body possesses a convex radius.

26. The spoke of claim 25 where the convex radius is positioned proximal to an edge formed between the radially inner surface of the outer compliant band.

27. The spoke of claim 17 wherein the radially inner end of the radially outer support element and the radially outer end of the radially inner support element are positioned a distance of at least four times the distance apart from one another in the radial direction as the average thickness of the elongated reinforcements comprising the radially outer support element and radially inner support element and both the radially inner end of the radially outer support element and the radially outer end of the radially inner support element are positioned a distance in the circumferential direction from the distal surface of the middle elastomeric joint body of at least two times the average thickness of the elongated reinforcements comprising the radially outer support element and radially inner support element;
wherein the radially inner elastomeric joint body extends in a circumferential direction at the radially inner end of the first surface of the elastomeric joint body forming an inner elastomeric joint body flap.

28. The spoke of claim 16 wherein the outer elastomeric joint body flap extends a distance of at least the average thickness of the elongated reinforcements comprising the radially outer support element.

29. The spoke of claim 16 wherein the outer elastomeric joint body flap extends circumferentially equal to or past the outer end of the elongated reinforcement comprising the radially outer support element.

30. A spoke for a non-pneumatic tire for connecting a radially inner surface of an outer compliant band to a radially outer surface of a hub, the tire defining an axis of rotation about its center and a medial plane tangent to the axis of rotation, the spoke comprising:
a radially outer support element having a radially inner end, a radially outer end, a first side and a second side;
a radially outer elastomeric joint body connecting the radially outer end of the radially outer support element to the radially inner surface of the outer compliant band, the radially outer elastomeric joint body positioned on the second side of the radially outer support element, the elastomeric joint body having a first surface on the same side of the radially outer elastomeric joint body as the first side of the radially outer support element and a second surface on the same side of the radially outer elastomeric joint body as the second side of the radially outer support element;
wherein the radially outer support element is comprised of one or more elongated reinforcements having a rigidity greater than the elastomer comprising the radially outer elastomeric joint body, the elongated reinforcement having a thickness;
wherein the radially outer end of the radially outer support element is positioned from the radially inner surface of the outer compliant band a first distance Y measured in the radial direction of the tire of at least twice that of the thickness T of the elongated reinforcement; and
the radially outer end of the radially outer element is positioned from the first surface of the radially outer elastomeric joint body a second distance X measured in the circumferential direction of the tire of at least twice that of the thickness T of the elongated reinforcement;
a radially inner support element having a radially inner end, a radially outer end, a first side and a second side, the radially outer support element forming an interior angle with the radially inner support element, the interior angle positioned on a first side of the radially outer support element and a first side of the radially inner element;
a radially inner elastomeric joint body connecting the radially inner support element radially inner end to the radially hub and positioned on the second side of the radially inner support element;
a middle elastomeric joint body connecting the radially inner support element radially outer end and the radially outer support element radially inner end, the middle elastomeric joint body positioned on the first side the radially outer support element and the first side of the radially inner support element;
wherein the radially outer elastomeric joint body extends in a circumferential direction at the radially outer end of the first surface of the elastomeric joint body forming an outer elastomeric joint body flap.

31. The spoke of claim 30 wherein the radially inner support element is comprised of one or more elongated reinforcements having a rigidity greater than the elastomer comprising the radially outer joint body.

32. The spoke of claim 30 wherein the radially outer support element radially outer end is a free end.

33. The spoke of claim 30 wherein the radially inner end of the radially outer support element and the radially outer end of the radially inner support element are positioned a distance of at least four times the distance apart from one another in the radial direction as the average thickness of the elongated reinforcements comprising the radially outer support element and radially inner support element and both the radially inner end of the radially outer support element and the radially outer end of the radially inner support element are positioned a distance in the circumferential direction from the distal surface of the middle elastomeric joint body of at least two times the average thickness of the elongated reinforcements comprising the radially outer support element and radially inner support element;
wherein the radially inner elastomeric joint body extends in a circumferential direction at the radially inner end of the first surface of the elastomeric joint body forming an inner elastomeric joint body flap.
